(19) United States
(12) Patent Application Publication
(10) Pub. No.: US 2013/0009737 A1
(43) Pub. Date: Jan. 10, 2013

(54) Transformer

(76) Inventors: Svend Erik Rocke, Billingstad (NO); Jan-Erik Knutsen, Oslo (NO)

(21) Appl. No.: 13/516,919

(22) PCT Filed: Dec. 15, 2010
(86) PCT No.: PCT/IB2010/003248

§ 371 Date: Sep. 27, 2012

(30) Foreign Application Priority Data
Dec. 18, 2009 (NO) 20093561

(51) Int. Cl. H02P 13/12; H01F 30/12

(52) U.S. Cl. 336/10; 336/5

(57) ABSTRACT

A polyphase transformer (1) comprising at least a first leg (2, 51) and a second leg (3, 52) of a magnetic material is described. The transformer comprises a single core with legs (2-4, 51-53) and yokes (27, 28, 54, 55). A primary winding (9, 15, 21, 56, 60, 62) is arranged on each one of the legs (2-4, 51-53) arranged to produce primary magnetic fields in the legs (2-4, 51-53), a secondary winding (12, 18, 24, 59, 61, 63) is arranged on each one of the legs (2-4, 51-53). The winding axis of the primary winding (9, 15, 21, 56, 60, 62) and the winding axis of the secondary winding (12, 18, 24, 59, 61, 63) are essentially parallel to each other on each one of the legs (2-4, 51-53). The transformer (1) also comprises at least one control winding (33-35, 45-47, 48, 49, 73-75) arranged to produce magnetic fields in each one of the legs (2-4, 51-53) being essentially orthogonal to the primary magnetic fields in the legs (2-4, 51-53).

### TECHNICAL FIELD

The present invention relates to a transformer and to an electric power distribution system comprising such a transformer. Primarily, but not limited to, the present invention relates to a high voltage transformer for an electric power distribution system in the form of an offshore system for electric power transmission from a power supply to a consumer means over a power transmission line comprising an offshore cable section.

### BACKGROUND OF THE INVENTION

Offshore systems may be used to pump oil and/or gas from wells below the sea floor. Such systems may include pumps driven by electric pump motors for the pumping of the oil and/or gas. Such pumps may be situated hundreds of kilometres from the shoreline and may be supplied with electric power from a power supply arranged onshore. When power is supplied over cables of such length different problems may arise such as, e.g., charging of the cable feeding electricity to the pump. The charging of the cable may give rise to an over-voltage at the pump motor, which ultimately may damage the pump motor, connection system, cable and/or topside electrical equipment. Furthermore, during operation of a pump connected to the power supply system, the load on the electric motor driving the pump may vary over time. Reduction of the load further enhances the problem with charging of the cable feeding the pump.

In order to resolve this problem it is desirable to provide a control means for control of the voltage to the pump motor. The control means may be in the form of a transformer with a controllable voltage output. Traditionally a controllable voltage output from a transformer has been provided by arranging tappings on the windings, which tappings are brought out to terminals so that the number of turns on one winding can be changed. The voltage between each tapping is dependent on the number of turns between each tap. The taps are connected to a type of power switch called a tap changer. Tap changers are, however, mechanically complicated and require frequent maintenance making them unsuitable for placement on the sea floor.

U.S. Pat. No. 6,933,822 to Haugs et al. describes a magnetically influenced current or voltage regulator and a magnetically influenced transformer. The problem of controlling a pump motor on the sea floor is also described. However, Haugs et al. describes only a one-phase transformer design. For many reasons it is desirable to use three-phase voltage to drive high power applications such as pump motors for pumping oil from the sea floor. In the patent it is suggested to use three identical, essentially independent single phase structures for providing a three-phase output.

U.S. Pat. No. 6,137,391 to Mitamura et al. describes a three phase flux-controlled type variable transformer. The transformer comprises a first and a second magnetic circuit and two separate magnetic cores. A control winding is arranged to induce a magnetic field that is orthogonal to a primary magnetic field which is applied by a primary winding. The voltage from a secondary winding may be continuously changed by adjusting the exciting current flowing in the control winding. The transformer described in Mitamura is, however, too complicated to make it suitable for an offshore power distribution system, in particular for placement of the transformer on the sea floor.

### SUMMARY OF THE INVENTION

It is an object of the present invention to provide a device for controlling the voltage to power consumers placed on the sea floor, which device solves the problems with the prior art.

It is an object of the present invention to provide a polyphase transformer which is suitable for placement on the sea floor and from which it is possible to control the output voltage.

Another object of the present invention is to provide a polyphase transformer which is robust and uncomplicated while still providing the possibility of controlling the voltage output from the transformer.

A further object of the present invention is to provide a polyphase transformer comprising at least three primary windings, three secondary windings and at least one control winding with which it is possible to control the voltage output on the secondary winding, wherein the transformer is robust, compact and suitable for placement on the sea floor.

At least one of the above objects is fulfilled with a transformer according to the independent claim 1.

Further advantages with the invention are provided with the features of the dependent claims.

According to a first aspect of the present invention a polyphase transformer is provided comprising at least a first leg and a second leg of a magnetic material, each leg comprising a length axis, an upper end and a lower end. The transformer also comprises an upper yoke being in contact with the upper end of each leg and having a length axis extending between the legs essentially orthogonal to the length axes of the legs and a lower yoke being in contact with the lower ends of each leg and having a length axis extending between the legs essentially parallel to the length axis of the upper yoke. The transformer further comprises a primary winding arranged on each one of the legs arranged to produce primary magnetic fields in the legs and a secondary winding arranged on each one of the legs, wherein the winding axis of the primary winding and the winding axis of the secondary winding are essentially parallel to each other on each one of the legs. The transformer is characterized in that it also comprises at least one control winding arranged to produce magnetic fields in each one of the legs being essentially orthogonal to the primary magnetic fields in the legs.

Polyphase transformers are almost exclusively three phase transformers. Thus, the transformer according to the invention is primarily a three phase transformer.

As the magnetic field (and flux) from the control winding is perpendicular to that of the primary and secondary windings, there is no mutual inductance. The total flux in the transformer core will however depend on all flux density contributions. As a result the magnetizing inductance of the transformer core can be controlled by adjusting the control current.

The transformer magnetizing inductance could be varied in such a way as to compensate the line capacitance, i.e. reactive power compensation. Compensating the reactive power produced in the cable will reduce the voltage rise over the cable. As the voltage rise is the main limiting factor in very long transmission systems, this function will increase maximum step-out distance for a power transmission system.

The yokes and the legs may together form a single core constituting a single magnetic circuit. Thus, the transformer may be a single core transformer.

Transformers according to preferred embodiments of the invention having three parallel legs between two parallel yokes are often called E-I transformers due to their resemblance in geometry with the letters E and I put together.

The winding axis of the primary winding and the winding axis of the secondary winding may be essentially parallel to length axis of the corresponding leg on each one of the legs. This corresponds to the geometry in a more conventional transformer.

A control winding may be arranged on at least one of the upper yoke and the lower yoke having a winding axis being essentially orthogonal to the winding axis of the primary winding.

A control winding may be arranged on the lower yoke as well as on the upper yoke, which control windings have parallel winding axes. Such an arrangement of the control windings is advantageous in that it produces an even magnetic field in the yokes as well as in the legs compared to a case with a control winding on only one of the yokes. The control windings may be connected in series or alternatively in parallel depending on which is most suitable for the specific application.

The winding axes of said at least one control winding may be orthogonal to the length axes of the legs, and wherein the control winding is arranged in a groove between each leg and the corresponding yoke. The groove may be arranged in the legs or in the yokes. In the finished transformer an opening is created for the control winding between each leg and each yoke.

As an alternative to having the control windings arranged only around the yokes a control winding may be arranged around at least parts of each one of the leg as well as at least parts of the adjacent yoke, wherein the winding axis of each control winding is essentially parallel to the yokes. With such an arrangement the provision of openings between the yokes and the legs may be avoided. Thus, the efficiency of the transformer may be optimized. Furthermore the control windings may be controlled individually to control each phase of the transformer.

In case that it is not important to control each phase individually the control windings may be connected in series or in parallel.

The polyphase transformer may have legs that are essentially tubular around their length axes and the upper and lower yokes are provided with holes corresponding to the holes of the tubes. The primary winding and the secondary winding of each leg are wound through the hole in the corresponding leg to produce a primary magnetic field in the leg orthogonal to the length axis of the corresponding leg. Such a transformer is compact and provides a favourable geometry for the magnetic flux.

In a transformer in which the legs are tubular a control winding may be arranged on each leg to produce a control magnetic field along the length axis of each leg. Alternatively a control winding may be arranged on only some of the legs in the transformer.

Each tubular leg may have a concentric groove between the inner surface and the outer surface of the tubular leg, which groove in the direction of the length axis of the leg extends along the main part of the leg, in which groove the control winding is arranged. With such grooves for the control windings the control windings are well protected. Alternatively the control windings may be arranged on the outside of each leg.

The polyphase transformer may be arranged so that, wherein the legs, the yokes and the windings are enclosed by a cover, which is filled with oil. The oil insulates the windings in order to avoid electrical discharges in the transformer.

Almost all polyphase transformers in use are three-phase transformers. A three-phase transformer according to a preferred embodiment of the invention has three legs. It is however possible within the scope of the invention to have more than three phases and three legs and to have only two phases and two legs. It is also possible within the scope of the invention to have e.g. three phases and five legs.

The primary windings may be arranged for a voltage of at least 400 V, preferably at least 1000 V. It is primarily for such high-voltage applications that the invention is intended to be used.

According to a second aspect of the present invention a polyphase transformer according to the invention is used placed on the sea floor connected to power consumers on the sea floor. It is primarily for such use the transformer according to the invention is intended.

In the following preferred embodiments of the invention will be described with reference to the drawings.

### SHORT DESCRIPTION OF THE DRAWINGS

FIG. 1 shows a transformer according to a first embodiment of the present invention.

FIG. 2 shows a transformer connected to a motor, which both are arranged on the sea floor.

FIG. 3 shows a transformer according to a second embodiment of the present invention.

FIG. 4 shows a transformer according to a third embodiment of the present invention.

FIG. 5 shows a transformer according to a fourth embodiment of the present invention.

FIG. 6 is a cross-sectional view of the transformer in FIG. 5.

### DESCRIPTION OF PREFERRED EMBODIMENTS OF THE INVENTION

In the following description of preferred embodiments of the invention similar elements or features in different figures will be denoted with the same reference numeral. It is to be noted that the drawings are not drawn to scale.

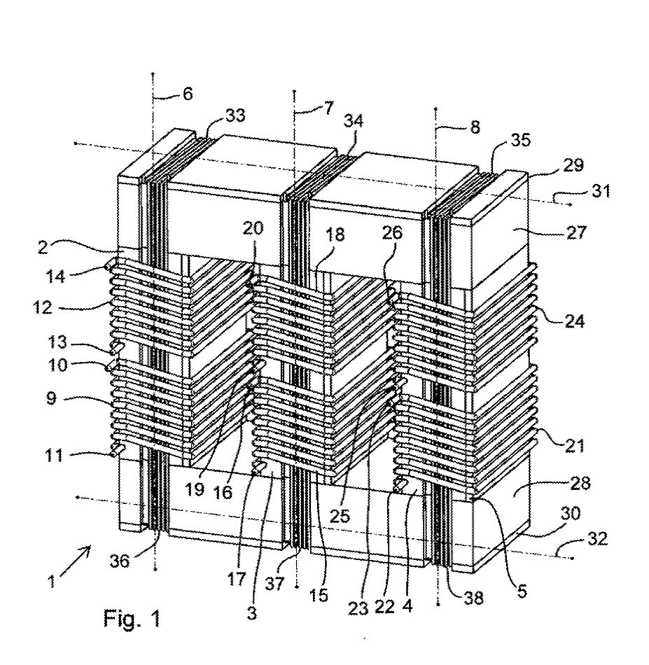

FIG. 1 shows a transformer 1 according to a first embodiment of the present invention. The transformer 1 comprises a first leg 2, a second leg 3, and a third leg 4. Each one of the legs 2-4, comprises a large number of stacked plates of a magnetic material such as magnetic steel. One of the plates 5 is indicated in the third leg 4. The first leg 2 has a first length axis 6. The second leg 3 has a second length axis 7. The third leg 4 has a third length axis 8. The length axes 6-8 of the legs 2-4 are parallel to each other. A first primary winding 9 having a first tap 10 and a second tap 11 is arranged on the first leg 2. A first secondary winding 12 having a first tap 13 and a second tap 14 is arranged on the first leg 2. The winding axis of the first primary winding 9 is parallel to the winding axis of the first secondary winding 12 and parallel to the length axis 6 of the first leg. A second primary winding 15, with a first tap 16 and a second tap 17, and a second secondary winding 18, with a first tap 19 and a second tap 20, are arranged on the second leg 3. The winding axis of the second primary winding 15 is parallel to the winding axis of the second secondary winding 18 and parallel to the length axis 7 of the second leg 3. A third primary winding 21, with a first tap 22 and a second tap 23, and a third secondary winding 24, with a first tap 25 and a second tap 26, are arranged on the third leg 4. The winding axis of the third primary winding 21 is parallel to the winding axis of the third secondary winding 24 and parallel to the length axis 8 of the third leg 4. The transformer 1 also comprises an upper yoke 27 being in contact with all of the legs 2-4 and a lower yoke 28 being in contact with all of the legs 2-4. Each one of the yokes 27, 28, comprises a large number of stacked plates of a magnetic material such as magnetic steel. By way of example, one of the plates 29 in the upper yoke 27 is shown in the figure and one of the plates 30 in the lower yoke 28 is shown in the figure. As seen in the figures the plates 5, of the legs 2-4 are arranged so that the length axes 6-8, of the legs 2-4, are parallel to the planes defined by the plates 5. Correspondingly, the length axes 31, 32, of the yokes 27, 28, are parallel to the planes defined by the plates 29, 30, of the yokes. The primary windings 9, 15, 21, are arranged to produce a magnetic field in the corresponding legs 2-4, when a voltage is applied over the taps 10, 11, 16, 17, 22, 23, of the primary windings 9, 15, 21. The produced magnetic fields in the legs 6-8 will be directed along the length axes 6-8, of the legs 2-4. The legs 2-4 and the yokes 27, 28, form a single core constituting a single magnetic circuit. A transformer 1 as shown in FIG. 1 is usually called an E-I transformer.

The transformer 1 also comprises a first control winding 33, a second control winding 34, and a third control winding 35, which are arranged around the first leg 2, as well as the adjacent yokes 27, 28, the second leg 3 as well as the adjacent yokes 27, 28, and the third leg 4, as well as the adjacent yokes 27, 28, wherein the winding axes of the control windings 33, 34, 35, are parallel to the yokes 27, 28. The control windings 33-35 are arranged to produce magnetic fields in the legs 2-4, being orthogonal to the magnetic fields produced by the primary windings 9, 15, 21. The legs 2-4, and the yokes 27, 28, are provided with grooves 36, 37, 38 for each one of the control windings 33-35, so that the control windings may be recessed below the main surfaces of the legs 2-4, and the yokes 27, 28. In this way the primary windings 9, 15, 16, and the secondary windings 12, 18, 24, may be wound around the legs 2-4 and the control windings 33-35 without interfering with the control windings 33-35.

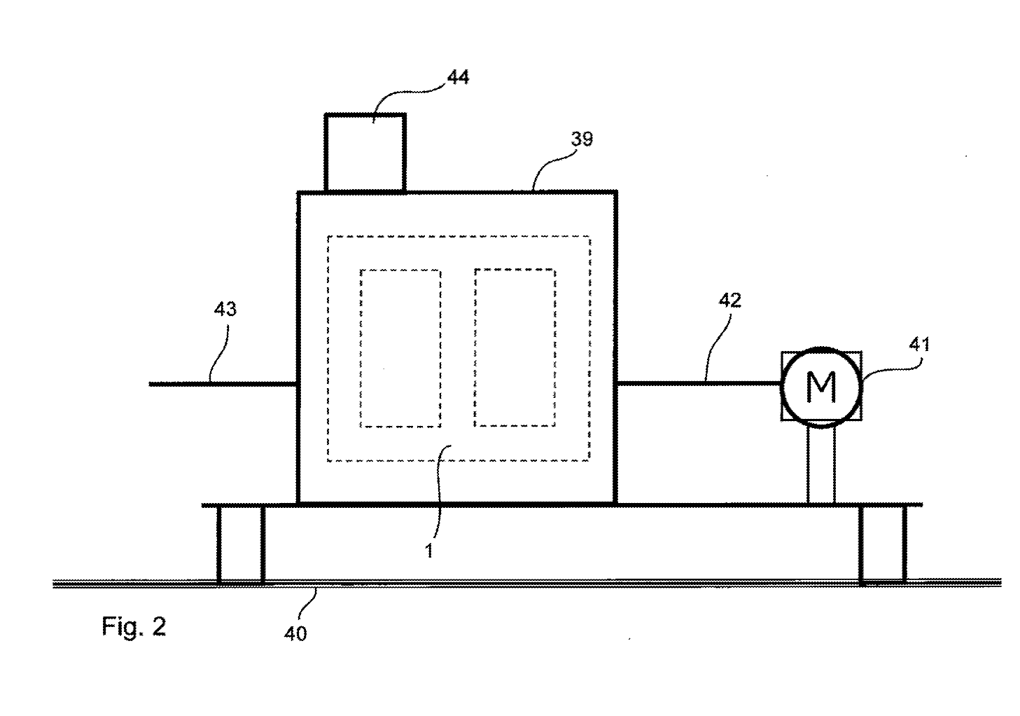

FIG. 2 shows a transformer 1 comprising a cover 39 which encloses the legs 2-4, the yokes 27, 28, and the windings. The cover 39 is filled with oil. The transformer 1 is arranged on the sea floor 40. The secondary windings 12, 18, 24, of the transformer are connected to a power consumer in the form of a motor 41 by means of a cable 42. The primary windings 9, 15, 21, of the transformer 1 are connected to a supply cable 43 which supplies electrical energy from a power source located on-shore. The power source could however also be located offshore on a platform, or floating production unit, or the like. A control device 44 is arranged connected to the transformer 1 and is arranged to control the voltage on the control windings 33-35. The control device 44 may be arranged to apply a portion of the voltage supplied with the supply cable 43.

With reference to FIG. 1 and FIG. 2 the operation of the transformer and the control device will now be described. In operation the primary windings 9, 15, 21, are connected to the supply cable and the control windings 33-35 are connected to a control voltage supplied from the control device 44, which in this example is a portion of the voltage applied to the corresponding primary winding. The voltage over the primary windings 9, 15, 21, will drive currents through the primary windings which in turn will induce primary magnetic fields in the legs 2-4. The primary magnetic fields will induce currents in the secondary windings 12, 18, 24. When no voltage is applied to the control windings 33-35 the voltage over the secondary windings 12, 18, 24, will be a fraction of the voltage over the primary windings 9, 15, 21, which fraction is equal to the number of turns in the secondary windings 12, 18, 24, divided by the number of turns in the primary windings. When the voltage over the control windings 33-35 increases the magnetic fields orthogonal to the primary magnetic fields will increase and result in a lowered voltage over the secondary windings 12, 18, 24. Thus, by increasing the voltage over the control windings 33-35, the voltage over the secondary windings 12, 18, 24, may be decreased.

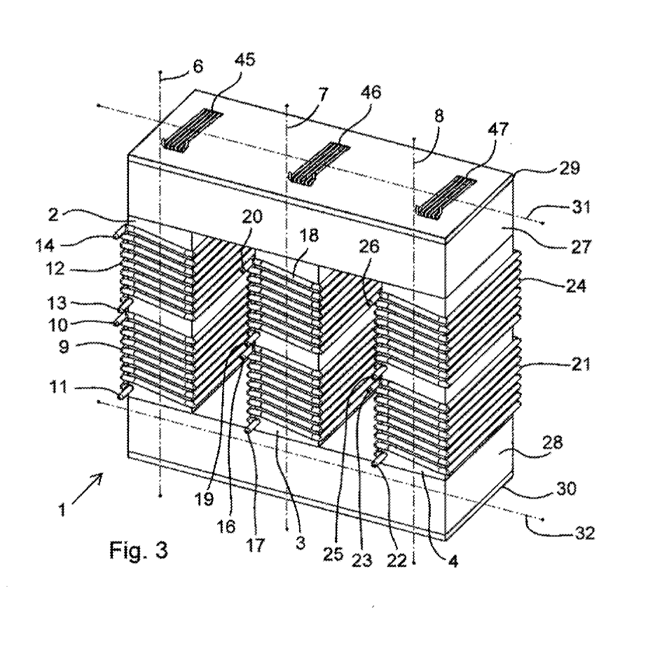

FIG. 3 shows a transformer 1 according to a second embodiment of the present invention. The only difference between this second embodiment and the first embodiment shown in FIG. 1 is that the control windings 45-47 are not wound around the entire legs but only the central portions of them. This embodiment of the invention is advantageous as more of the iron core is saturated by the control winding, thus less control current is needed to lower the voltage in the main windings.

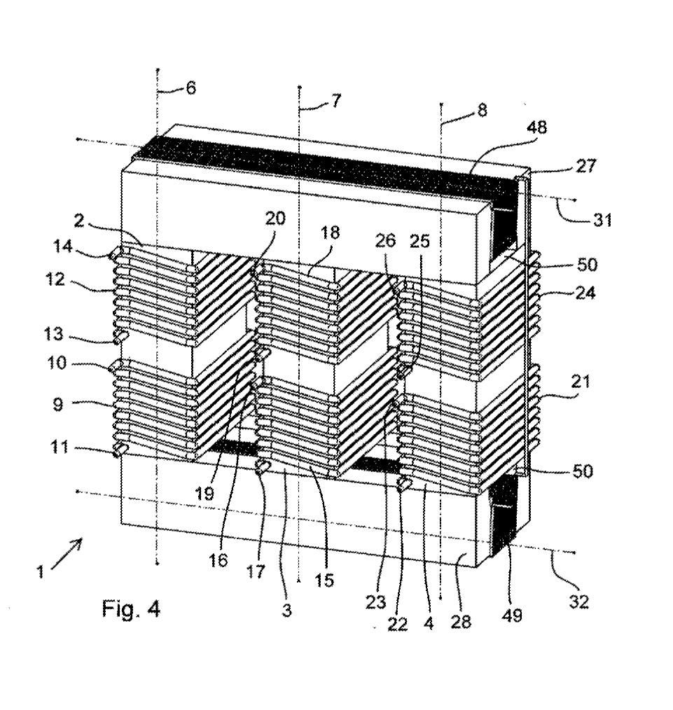

FIG. 4 shows a transformer 1 according to a third embodiment of the present invention. The transformer 1 according to FIG. 4 differs from the embodiments in FIGS. 1 and 3 in that the control windings 48, 49, are orthogonal to the control windings in the embodiments of FIGS. 1 and 3 while still being arranged to produce a control magnetic field that is orthogonal to the primary magnetic fields induced by the primary windings 9, 15, 21. A first control winding 48 is wound around the upper yoke 27 and a second control winding 49 is wound around the lower yoke 28. In order to make it possible to wind the control windings 48, 49, as shown in FIG. 4 the yokes 27, 28, are preferably provided with recesses or grooves which form openings 50 between the legs 2-4 and the yokes 27, 28, on the assembled transformer 1. The openings will result in a higher resistance for the magnetic field which leads to losses and a decrease in the overall efficiency of the transformer 1.

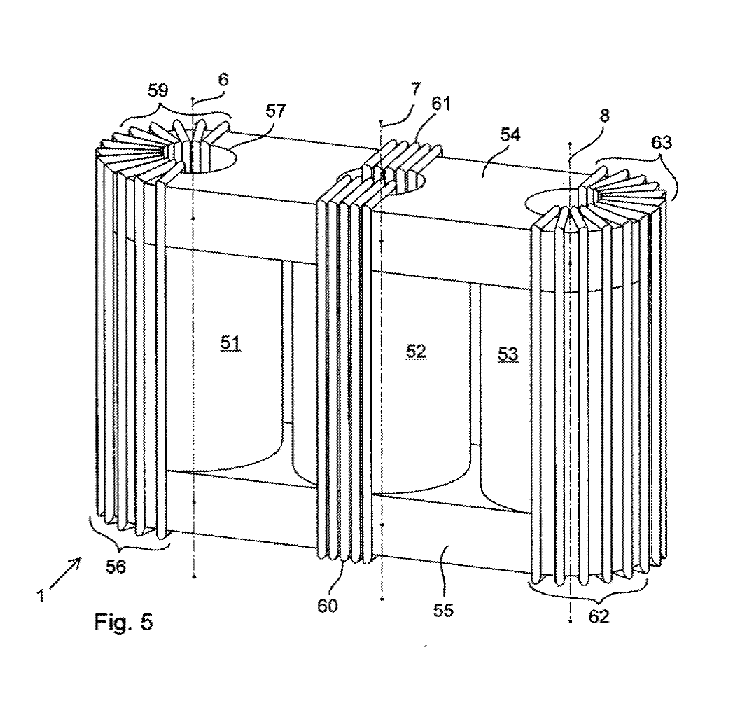

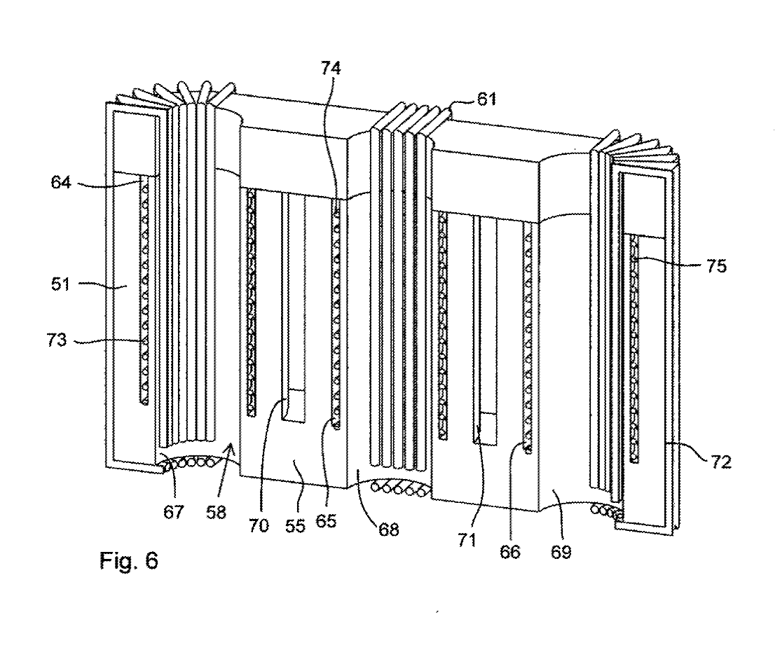

FIG. 5 shows a transformer 1 according to a fourth embodiment of the present invention in which the legs 51-53 are tubular. The legs 51-53 are circularly symmetrical around their length axes 6-8. The upper yoke 54 and the lower yoke 55 have through going holes 57, 58 (see also FIG. 6), corresponding to the holes of the legs 51-53. The first primary winding 56, and the first secondary winding 59 are wound through the hole of the first leg 51 and the corresponding holes 57, 58 of the yokes 54, 55. A second primary winding 60 and a second secondary winding 61 are wound in the corresponding way on the second leg 52, and a third primary winding 62 and a third secondary winding 63 are wound in the corresponding way on the third leg 53. The primary windings 56, 60, 62, are arranged to produce primary magnetic fields in the legs 51-53 orthogonal to the length axis 6, 7, 8, of the corresponding leg 51-53. Control windings (see FIG. 6) are wound to produce magnetic fields along the length axes of the legs 51-53.

FIG. 6 is a cross-sectional view of the transformer 1 shown in FIG. 5. Each tubular leg 51-53 has a concentric groove 64-66, between the inner surface 67-69 and the outer surface 70-72 of the tubular leg, which groove 64-66 in the direction of the length axis 6-8 of the leg 51-53 extends along the main part of the leg, in which groove the control winding 73-75 is arranged.

The described embodiments may be modified in many ways without departing from the spirit and scope of the present invention which is limited only by the appended claims.

In the described embodiment the windings are shown as being separated along the legs. It is however possible to have the windings arranged integrated with each other.

Even though polyphase transformers almost exclusively are arranged with three phases it is possible within the scope of the invention to arrange the transformer with two phases or more than three phases.

In each one of the embodiments described above the control windings may be connected in series or in parallel. Alternatively, the control windings may be controlled individually.

The control windings are connected to a voltage, which most often would be a direct current voltage, but an alternating voltage is also conceivable, and this voltage gives rise to a current in the control windings.

It is possible to orient the plates of the yokes perpendicular to the orientation shown in the figures as long as the normal to the planes defined by the plates is essentially perpendicular to the direction of the magnetic flux.

1. A polyphase transformer (1) comprising at least a first leg (2, 51) and a second leg (3, 52) of a magnetic material, each leg (2-4, 51-53) comprising a length axis (6-8), an upper end and a lower end; an upper yoke (27, 54) being in contact with the upper end of each leg (2-4, 51-53) and having a length axis (31) extending between the legs (2-4) essentially orthogonal to the length axes (6-8) of the legs (2-4, 51-53); a lower yoke (28, 55) being in contact with the lower ends of each leg (2-4, 51-53) and having a length axis (32) extending between the legs (2-4, 51-53) essentially parallel to the length axis (31) of the upper yoke (27, 54); a primary winding (9, 15, 21, 56, 60, 62) arranged on each one of the legs (2-4, 51-53) arranged to produce primary magnetic fields in the legs (2-4, 51-53); a secondary winding (12, 18, 24, 59, 61, 63) arranged on each one of the legs (2-4, 51-53), wherein the winding axis of the primary winding (9, 15, 21, 56, 60, 62) and the winding axis of the secondary winding (12, 18, 24, 59, 61, 63) are essentially parallel to each other on each one of the legs (2-4, 51-53), characterized in that it also comprises at least one control winding (33-35, 45-47, 48, 49, 73-75) arranged to produce magnetic fields in each one of the legs (2-4, 51-53) being essentially orthogonal to the primary magnetic fields in the legs (2-4, 51-53).

2. The polyphase transformer (1) of claim 1, wherein the legs (2-4, 51-53) and the yokes (27-28, 54-55) together form a single core constituting a single magnetic circuit.

3. The polyphase transformer (1) of claim 1 or 2, wherein the winding axis of the primary winding (9, 15, 21) and the winding axis of the secondary winding (12, 18, 24) are essentially parallel to the length axis (6-8) of the corresponding leg (2-4) on each one of the legs (2-4).

4. The polyphase transformer (1) of claim 3, comprising a control winding (48, 49) arranged on at least one of the upper yoke (27) and the lower yoke (28) having a winding axis being essentially orthogonal to the winding axis of the primary winding (9, 15, 21).

5. The polyphase transformer (1) according to claim 4, wherein the winding axis of said at least one control winding (48, 49) is orthogonal to the length axes (6-8) of the legs (2-4) and wherein the control winding (48, 49) is arranged in a groove (50) between each leg (2-4) and the corresponding yoke (27, 28).

6. The polyphase transformer (1) of claim 3, 4 or 5, comprising a control winding (48, 49) arranged on the lower yoke (28) as well as on the upper yoke (27), which control windings (48, 49) have parallel winding axes.

7. The polyphase transformer (1) according to claim 3, comprising a control winding (33-35) arranged around at least parts of each one of the legs (2-4) as well as at least parts of the adjacent yoke (27, 28), wherein the winding axis of each control winding (33-35) is essentially parallel to the length axes (31, 32) of the yokes (27, 28).

8. The polyphase transformer (1) according to claim 1, wherein the legs (51-53) are essentially tubular around their length axes (6-8) and the upper yoke (54) and lower yoke (55) are provided with holes (57, 58) corresponding to the holes of the tubular legs (51-53), wherein the primary winding (56, 60, 62) and the secondary winding (59, 61, 63) of each leg (51-53) are wound through the hole in the corresponding leg (51-53) to produce a primary magnetic field in the leg (51-53) orthogonal to the length axis (6-8) of the corresponding leg (51-53).

9. The polyphase transformer (1) according to claim 8, wherein the control winding (73-75) is arranged on each leg (51-53) to produce a control magnetic field along the length axis (6-8) of the leg (51-53).

10. The polyphase transformer (1) of claim 9, wherein each tubular leg (51-53) has a concentric groove (64-66) between the inner surface and the outer surface of the tubular leg (51-53), which groove (64-66) in the direction of the length axis (6-8) of the leg (51-53) extends along the main part of the leg (51-53), in which groove (64-66) the control winding (73-75) is arranged.

11. The polyphase transformer (1) according to any one of claims 6-10, wherein the control windings (33-35, 45-47, 48, 49, 73-75) are connected in series.

12. The polyphase transformer (1) according to any one of claims 6-10, wherein the control windings (33-35, 45-47, 48, 49, 73-75) are connected in parallel.

13. The polyphase transformer (1) according to any one of claims 6-10, wherein each control winding (33-35, 45-47, 48, 49, 73-75) is arranged to be controlled individually.

14. The polyphase transformer (1) according to any one of the preceding claims, comprising a cover (39) which encloses the legs (2-4, 51-53), the yokes (27, 28, 54, 55) and the windings (9, 15, 21, 56, 60, 62, 12, 18, 24, 59, 61, 63, 33-35, 45-47, 48, 49, 73-75), which cover (39) is filled with oil.

15. The polyphase transformer (1) according to any one of the preceding claims, having three legs (2-4, 51-53).

16. The polyphase transformer (1) according to any one of the preceding claims, wherein the primary windings (9, 15, 21, 56, 60, 62) are arranged for a voltage of at least 400 V, preferably at least 1000 V.

17. Use of a polyphase transformer (1) according to any one of the preceding claims placed on the sea floor connected to power consumers on the sea floor.
